(19) United States
(12) Patent Application Publication
(10) Pub. No.: US 2007/0104943 A1
(43) Pub. Date: May 10, 2007

(54) Filled polymer composites

(75) Inventor: Andrew S. D'Souza, Little Canada, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/271,025

(22) Filed: Nov. 10, 2005

(51) Int. Cl. B32B 5/22

(52) U.S. Cl. 428/317.9

(57) ABSTRACT

Filled resin composites comprising at least one polymeric resin and microspheres wherein said microspheres have an average size D50 of 25 micrometers or less and a 10 percent collapse strength of at least 10,000 PSI (68.8 Mpa) are disclosed. Such resins exhibit surprising and previously unattained combination of superior physical properties. Articles made with such composites are disclosed.

### FIELD

The present invention relates to polymer or resin composites filled with hollow microspheres or bubbles.

### BACKGROUND

It is known in the art to incorporate hollow microspheres in polymeric composites, e.g., thermoset and thermoplastic resins, to replace costly polymer components or reduce the density of resultant articles. For example, 3M Company sells 3M Brand S60HS glass bubbles which are used, inter alia, as fillers in polymeric composites. Such glass bubbles have an average size D50 of 29 micrometers and an average size D90 of 45 micrometers.

Although glass bubbles have often been used to successfully reduce density of the final composites, such resultant composites have often exhibited undesirable loss of certain physical properties such as impact strength and tensile strength. Incorporation of non-reinforcing fillers into polymer matrices results in a decrease in the mechanical strength (tensile, impact, etc.) of the filled polymer composition. Non-reinforcing fillers can be defined as any particle with an aspect ratio (length over diameter) less than 2. It is believed that the loss in mechanical strength is due primarily to the filler causing a disruption of the polymer chains entanglement capability and also due to the inefficient bonding between the polymer and the filler; where the bond strength is assumed to be less than the tensile strength of the polymer chains themselves. It is known to use coupling agents (e.g., silane treatments) to improve the strength of the bond between the filler particles and the polymeric matrix, but more improvement of the physical properties of resultant composites is desired.

Illustrative examples of filled resin composites are disclosed in U.S. Pat. No. 3,769,126 (Kolek), U.S. Pat. No. 4,243,575 (Myers et al.), U.S. Pat. No. 4,923,520 (Anzai et al.), and U.S. Pat. No. 5,695,851 (Watanabe et al.) and EP Application No. 1,142,685 (Akesson).

The need exists for improved composites of polymer or resin matrices filled with hollow microspheres.

### SUMMARY

The present invention is directed to polymer or resin composites containing hollow microspheres or bubbles and articles made with such composites. It has been discovered that resultant composites exhibiting improved properties can be made using certain hollow microspheres as described below.

In brief summary, composites of the invention comprise a polymer or resin matrix and a plurality of hollow microspheres as described herein. Composites of the invention differ from conventional composites in that the microspheres are relatively smaller and relatively stronger than the microspheres used in previously known composites.

Composites of the invention exhibit surprising and previously unattained combinations of superior physical properties including impact strength and elongation. In accordance with the invention, articles made with such composites can provide surprising advantageous results.

### DETAILED DESCRIPTION OF ILLUSTRATIVE EMBODIMENTS

For purposes of the present invention, the following terms used in this application are defined as follows:

“Average Size D50” is the diameter at which, on average, 50 percent (by number) of the microspheres is equal to or greater in diameter.

“Average Size D90” is the diameter at which, on average, 90 percent (by number) of the microspheres is equal to or greater in diameter.

Composites of the invention comprise a polymer or resin matrix and a plurality of hollow microspheres. In some instance, composites of the invention consist essentially of such a matrix, microspheres as described below, and desired additives.

### Microspheres

The hollow microspheres used in composites of the invention will typically have an average size D50 of 25 micrometers or less and a 10 percent collapse strength of at least 10,000 PSI (68.8 Mpa) measured using ASTM D3102-72; “Hydrostatic Collapse Strength of Hollow Glass Microspheres”.

The 10 percent crush strength of the bubbles is preferably at least 15,000 PSI (103 Mpa) and more preferably at least 18,000 PSI (124 Mpa) to withstand thermoplastic extrusion and injection molding operations commonly encountered when manufacturing composite articles from such composites.

The bubbles used in composites of the invention are smaller than those conventionally used in composites. Typically, the bubbles will have an average size D50 of about 25 microns or less, preferably about 20 microns or less. Typically, the bubbles will have an average size D90 of about 50 microns or less, preferably about 40 microns or less. In some illustrative preferred embodiments, the bubbles have an average D50 size of about 25 microns or less and an average D90 size of about 50 microns or less, and other some illustrative embodiments even an average D50 size of about 20 microns or less and an average D90 size of about 40 microns or less.

The microspheres preferably include glass or ceramic materials and most preferably are hollow glass microspheres.

Polymeric Matrix

The polymeric matrix is generally any thermoplastic or thermosetting polymer or copolymer in which hollow microspheres may be employed. The polymeric matrix includes both hydrocarbon and non-hydrocarbon polymers. Examples of useful polymeric matrices include, but are not limited to, polyamides, polyimides, polyethers, polyurethanes, polyolefins, polystyrenes, polyesters, polycarbonates, polyketones, polyureas, polyvinyl resins, polyacrylates, polymethylacrylates, and fluorinated polymers.

One preferred application involves melt-processable polymers where the constituents are dispersed in melt mixing stage prior to formation of an extruded or molded polymer article.

For purposes of the invention, melt processable compositions are those that are capable of being processed while at least a portion of the composition is in a molten state.

Conventionally recognized melt processing methods and equipment may be employed in processing compositions of the present invention. Non-limiting examples of melt processing practices include extrusion, injection molding, batch mixing, rotation molding, and pultrusion.

Preferred polymeric matrices include polyolefins (e.g., high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrenes, polystyrene copolymers (e.g., high impact polystyrene, acrylonitrile butadiene styrene copolymer), polyacrylates, polymethacrylates, polyesters, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters or combinations thereof.

Elastomers are another subset of polymers suitable for use as a polymeric matrix. Useful elastomeric polymeric resins (i.e., elastomers) include thermoplastic and thermoset elastomeric polymeric resins, for example, polybutadiene, polyisobutylene, ethylene-propylene copolymers, ethylene-propylene-diene terpolymers, sulfonated ethylene-propylene-diene terpolymers, polychloroprene, poly(2,3-dimethylbutadiene), poly(butadiene-co-pentadiene), chlorosulfonated polyethylenes, polysulfide elastomers, silicone elastomers, poly(butadiene-co-nitrile), hydrogenated nitrile-butadiene copolymers, acrylic elastomers, ethylene-acrylate copolymers.

Useful thermoplastic elastomeric polymer resins include block copolymers, made up of blocks of glassy or crystalline blocks such as, for example, polystyrene, poly(vinyltoluene), poly(t-butylstyrene), and polyester, and the elastomeric blocks such as polybutadiene, polyisoprene, ethylene-propylene copolymers, ethylene-butylene copolymers, polyether ester and the like as, for example, poly(styrene-butadiene-styrene) block copolymers marketed by Shell Chemical Company, Houston, Tex., under the trade designation “KRATON”. Copolymers and/or mixtures of these aforementioned elastomeric polymeric resins can also be used.

Useful polymeric matrices also include fluoropolymers, that is, at least partially fluorinated polymers. Useful fluoropolymers include, for example, those that are preparable (e.g., by free-radical polymerization) from monomers comprising 25 chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorofluoroethylene, hexafluoropropylene, vinyl fluoride, a perfluorinated vinyl ether (e.g., a perfluoro(alkoxy vinyl ether) such as CF₃OCF₂CF₂CF₂OCF═CF₂, or a perfluoro(alkyl vinyl ether) such as perfluoro(methyl vinyl ether) or perfluoro(propyl vinyl ether)), cure site monomers such as for example, nitrile containing monomers (e.g., CF₂═CFO(CF₂)LCN, CF₂═CFO[CF₂CF(CF₃)O]_{q}(CF₂O)_{y}CF(CF₃)CN, CF₂═CF[OCF₂CF(CF₃)]ᵣO(CF₂)ₜCN, or CF₂═CFO(CF₂)ᵤOCF(CF₃)CN where L is 2 to 12; q is 0 to 4; r is 1 to 2; y is 0 to 6; t is 1 to 4; and u is 2 to 6), bromine containing monomers (e.g., Z-Rf-Ox-CF═CF₂, wherein Z is Br or I, Rf is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; copolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro(alkyl vinyl ether) copolymers (e.g., tetrafluoroethyleneperfluoro(propyl vinyl ether)); and combinations thereof.

Useful commercially available thermoplastic fluoropolymers include, for example, those marketed by Dyneon, LLC, Oakdale, Minn., under the trade designations DYNEON™THV (e.g., “THV 220”, “THV 400G”, “THV 500G”, “THV 815”, and “THV 610X”), “PVDF”, “PVF”, “TFEP”, “PFA”,“HTE”, “ETFE”, and “FEP”; those marketed by Atofina Chemicals, Philadelphia, Pa., under the trade designation “KYNAR” (e.g., “KYNAR™740”); those marketed by Solvay Solexis, Thorofare, N.J., under the trade designations “HYLAR” (e.g., “HYLAR™700”) and “HALAR™ ECTFE”; Allied Signal PCTFE; and DuPont TEFLON™.

The polymeric resin component of composites of the invention may comprise block copolymers as described in Assignee's copending U.S. Provisional Patent Application No. 60/628335, filed Nov. 16, 2004, (Docket No. 60207US002).

The block copolymers interact with the microspheres through functional moieties. Functional blocks typically have one or more polar moieties such as, for example, acids (e.g., —CO₂H, —SO₃H, —PO₃H); —OH; —SH; primary, secondary, or tertiary amines; ammonium N-substituted or unsubstituted amides and lactams; N-substituted or unsubstituted thioamides and thiolactams; anhydrides; linear or cyclic ethers and polyethers; isocyanates; cyanates; nitriles; carbamates; ureas; thioureas; heterocyclic amines (e.g., pyridine or imidazole)). Useful monomers that may be used to introduce such groups include, for example, acids (e.g., acrylic acid, methacrylic acid, itaconic acid, maleic acid, fumaric acid, and including methacrylic acid functionality formed via the acid catalyzed deprotection of t-butyl methacrylate monomeric units as described in U.S. Patent Publication No. 2004/0024130 (Nelson et al.)); acrylates and methacrylates (e.g., 2-hydroxyethyl acrylate), acrylamide and methacrylamide, N-substituted and N,N-disubstituted acrylamides (e.g., N-t-butylacrylamide, N,N-(dimethylamino)ethylacrylamide, N,N-dimethylacrylarnide, N,N-dimethylmethacrylamide), N-ethylacrylamide, N-hydroxyethylacrylamide, N-octylacrylamide, N-t-butylacrylamide, N,N-dimethylacrylamide, N,N-diethylacrylamide, and N-ethyl-N-dihydroxyethylacrylamide), aliphatic amines (e.g., 3-dimethylaminopropyl amine, N,N-dimethylethylenediamine); and heterocyclic monomers (e.g., 2-vinylpyridine, 4-vinylpyridine, 2-(2-aminoethyl)pyridine, 1-(2-aminoethyl)pyrrolidine, 3-aminoquinuclidine, N-vinylpyrrolidone, and N-vinylcaprolactam).

Other suitable blocks typically have one or more hydrophobic moieties such as, for example, aliphatic and aromatic hydrocarbon moieties such as those having at least about 4, 8, 12, or even 18 carbon atoms; fluorinated aliphatic and/or fluorinated aromatic hydrocarbon moieties, such as, for example, those having at least about 4, 8, 12, or even 18 carbon atoms; and silicone moieties.

Non-limiting examples of useful monomers for introducing such blocks include: hydrocarbon olefins such as ethylene, propylene, isoprene, styrene, and butadiene; cyclic siloxanes such as decamethylcyclopentasiloxane and decamethyltetrasiloxane; fluorinated olefins such as tetrafluoroethylene, hexafluoropropylene, trifluoroethylene, difluoroethylene, and chlorofluoroethylene; nonfluorinated alkyl acrylates and methacrylates such as butyl acrylate, isooctyl methacrylate lauryl acrylate, stearyl acrylate; fluorinated acrylates such as perfluoroalkylsulfonamidoalkyl acrylates and methacrylates having the formula H₂C═C(R₂)C(O)O—X—N(R)SO₂R_{f}′ wherein: R_{f}′ is —C₆F₁₃, —C₄F₉, or —C₃F₇; R is hydrogen, C₁ to C₁₀ alkyl, or C₆-C₁₀ aryl; and X is a divalent connecting group. Preferred examples include C₄F₉SO₂N(CH₃)C₂H₄OC(O)NH(C₆H₄)CH₂C₆H₄NHC(O)OC₂H₄OC(O)CH═CH₂C₄F₉SO₂N(CH₃)C₂H₄OC(O)NH(C₆H₄)CH₂C₆H₄NH or C(O)OC₂H₄OC(O)C(CH₃)═CH₂.

Such monomers may be readily obtained from commercial sources or prepared, for example, according to the procedures in U.S. Patent Publication No. 2004/0023016 (Cemohous et al.), the disclosure of which is incorporated herein by reference.

Other non-limiting examples of useful block copolymers having functional moieties include poly(isoprene-block-4-vinylpyridine); poly(isoprene-block-methacrylic acid); poly(isoprene-block-N,N-(dimethylamino)ethyl acrylate); poly(isoprene-block-2-diethylaminostyrene); poly(isoprene-block-glycidyl methacrylate); poly(isoprene-block-2-hydroxyethyl methacrylate); poly(isoprene-block-N-vinylpyrrolidone); poly(isoprene-block-methacrylic anhydride); poly(isoprene-block-(methacrylic anhydride-co-methacrylic acid)); poly(styrene-block-4-vinylpyridine); poly(styrene-block-2-vinylpyridine); poly(styrene-block-acrylic acid); poly(styrene-block-methacrylamide); poly(styrene-block-N-(3-aminopropyl)methacrylamide); poly(styrene-block-N,N-(dimethylamino)ethyl acrylate); poly(styrene-block-2-diethylaminostyrene); poly(styrene-block-glycidyl methacrylate); poly(styrene-block-2-hydroxyethyl methacrylate); poly(styrene-block-N-vinylpyrrolidone copolymer); poly(styrene-block-isoprene-block-4-vinylpyridine); poly(styrene-block-isoprene-block-glycidyl methacrylate); poly(styrene-block-isoprene-block-methacrylic acid); poly(styrene-block-isoprene-block-(methacrylic anhydride-co-methacrylic acid)); poly(styrene-block-isoprene-block-methacrylic anhydride); poly(butadiene-block-4-vinylpyridine); poly(butadiene-block-methacrylic acid); poly(butadiene-block-N,N-(dimethylamino)ethyl acrylate); poly(butadiene-block-2-diethylaminostyrene); poly(butadiene-block-glycidyl methacrylate); poly(butadiene-block-2-hydroxyethyl methacrylate); poly(butadiene-block-N-vinylpyrrolidone); poly(butadiene-block-methacrylic anhydride); poly(butadiene-block-(methacrylic anhydride-co-methacrylic acid); poly(styrene-block-butadiene-block-4-vinylpyridine); poly(styrene-block-butadiene-block-methacrylic acid); poly(styrene-block-butadiene-block-N,N-(dimethylamino)ethyl acrylate); poly(styrene-block-butadiene-block-2-diethylaminostyrene); poly(styrene-block-butadiene-block-glycidyl methacrylate); poly(styrene-block-butadiene-block-2-hydroxyethyl methacrylate); poly(styrene-block-butadiene-block-N-vinylpyrrolidone); poly(styrene-block-butadiene-block-methacrylic anhydride); poly(styrene-block-butadiene-block-(methacrylic anhydride-co-methacrylic acid)); and hydrogenated forms of poly(butadiene-block-4-vinylpyridine), poly(butadiene-block-methacrylic acid), poly(butadiene-block-N,N-(dimethylamino)ethyl acrylate), poly(butadiene-block-2-diethylaminostyrene), poly(butadiene-block-glycidyl methacrylate), poly(butadiene-block-2-hydroxyethyl methacrylate), poly(butadiene-block-N-vinylpyrrolidone), poly(butadiene-block-methacrylic anhydride), poly(butadiene-block-(methacrylic anhydride-co-methacrylic acid)), poly(isoprene-block-4-vinylpyridine), poly(isoprene-block-methacrylic acid), poly(isoprene-block-N,N-(dimethylamino)ethyl acrylate), poly(isoprene-block-2-diethylaminostyrene), poly(isoprene-block-glycidyl methacrylate), poly(isoprene-block-2-hydroxyethyl methacrylate), poly(isoprene-block-N-vinylpyrrolidone), poly(isoprene-block-methacrylic anhydride), poly(isoprene-block-(methacrylic anhydride-co-methacrylic acid)), poly(styrene-block-isoprene-block-glycidyl methacrylate), poly(styrene-block-isoprene-block-methacrylic acid), poly(styrene-block-isoprene-block-methacrylic anhydride-co-methacrylic acid), styrene-block-isoprene-block-methacrylic anhydride, poly(styrene-block-butadiene-block-4-vinylpyridine), poly(styrene-block-butadiene-block-methacrylic acid), poly(styrene-block-butadiene-block-N,N-(dimethylamino)ethyl acrylate), poly(styrene-block-butadiene-block-2-diethylaminostyrene), poly(styrene-block-butadiene-block-glycidyl methacrylate), poly(styrene-block-butadiene-block-2-hydroxyethyl methacrylate), poly(styrene-block-butadiene-block-N-vinylpyrrolidone), poly(styrene-block-butadiene-block-methacrylic anhydride), poly(styrene-block-butadiene-block-(methacrylic anhydride-co-methacrylic acid), poly(MeFBSEMA-block-methacrylic acid) (wherein “MeFBSEMA” refers to 2-(N-methylperfluorobutanesulfonamido)ethyl methacrylate, e.g., as available from 3M Company, Saint Paul, Minn.), poly(MeFBSEMA-block-t-butyl methacrylate), poly(styrene-block-t-butyl methacrylate-block-MeFBSEMA), poly(styrene-block-methacrylic anhydride-block-MeFBSEMA), poly(styrene-block-methacrylic acid-block-MeFBSEMA), poly(styrene-block-(methacrylic anhydride-co-methacrylic acid)-block-MeFBSEMA)), poly(styrene-block-(methacrylic anhydride-co-methacrylic acid-co-MeFBSEMA)), poly(styrene-block-(t-butyl methacrylate-co-MeFBSEMA)), poly(styrene-block-isoprene-block-t-butyl methacrylate-block-MeFBSEMA), poly(styrene-isoprene-block-methacrylic anhydride-block-MeFBSEMA), poly(styrene-isoprene-block-methacrylic acid-block-MeFBSEMA), poly(styrene-block-isoprene-block-(methacrylic anhydride-co-methacrylic acid)-block-MeFBSEMA), poly(styrene-block-isoprene-block-(methacrylic anhydride-co-methacrylic acid-co-MeFBSEMA)), poly(styrene-block-isoprene-block-(t-butyl methacrylate-co-MeFBSEMA)), poly(MeFBSEMA-block-methacrylic anhydride), poly(MeFBSEMA-block-(methacrylic acid-co-methacrylic anhydride)), poly(styrene-block-(t-butyl methacrylate-co-MeFBSEMA)), poly(styrene-block-butadiene-block-t-butyl methacrylate-block-MeFBSEMA), poly(styrene-butadiene-block-methacrylic anhydride-block-MeFBSEMA), poly(styrene-butadiene-block-methacrylic acid-block-MeFBSEMA), poly(styrene-block-butadiene-block-(methacrylic anhydride-co-methacrylic acid)-block-MeFBSEMA), poly(styrene-block-butadiene-block-(methacrylic anhydride-co-methacrylic acid-co-MeFBSEMA)), and poly(styrene-block-butadiene-block-(t-butyl methacrylate-co-MeFBSEMA)).

Generally, the block copolymer should be chosen such that at least one block is capable of interacting with the microspheres. The choice of remaining blocks of the block copolymer will typically be directed by the nature of any polymeric resin with which the block copolymer will be combined.

The block copolymers may be end-functionalized polymeric materials that can be synthesized by using functional initiators or by end-capping living polymer chains, as conventionally recognized in the art. The end-functionalized polymeric materials of the present invention may comprise a polymer terminated with a functional group on at least one chain end. The polymeric species may be homopolymers, copolymers, or block copolymers. For those polymers that have multiple chain ends, the functional groups may be the same or different. Non-limiting examples of functional groups include amine, anhydride, alcohol, carboxylic acid, thiol, maleate, silane, and halide. End-functionalization strategies using living polymerization methods known in the art can be utilized to provide these materials.

Any amount of block copolymer may be used, however, typically the block copolymer is included in an amount in a range of up to 5% by weight.

Coupling Agents

In a preferred embodiment, the microspheres may be treated with a coupling agent to enhance the interaction between the microspheres and the polymeric resin. It is desirable to select a coupling agent that matches or provides suitable reactivity with corresponding functional groups of the chosen polymer formulation. Illustrative examples of coupling agents include zirconates, silanes, or titanates. Typical titanate and zirconate coupling agents are known to those skilled in the art and a detailed overview of the uses and selection criteria for these materials can be found in Monte, S. J., Kenrich Petrochemicals, Inc., “Ken-React® Reference Manual—Titanate, Zirconate and Aluminate Coupling Agents”, Third Revised Edition, March, 1995. If used, coupling agents are commonly included in an amount of about 1 to 3% by weight.

Suitable silanes are coupled to glass surfaces through condensation reactions to form siloxane linkages with the siliceous filler. This treatment renders the filler more wettable or promotes the adhesion of materials to the microsphere surface. This provides a mechanism to bring about covalent, ionic or dipole bonding between inorganic fillers and organic matrices. Silane coupling agents are chosen based on the particular functionality desired. For example, an aminosilane glass treatment may be desirable for compounding with a block copolymer containing an anhydride, epoxy or isocyanate group. Alternatively, silane treatments with acidic functionality may require block copolymer selections to possess blocks capable of acid-base interactions, ionic or hydrogen bonding scenarios. Another approach to achieving intimate glass microsphere-block copolymer interactions is to functionalize the surface of microsphere with a suitable coupling agent that contains a polymerizable moiety, thus incorporating the material directly into the polymer backbone. Examples of polymerizable moieties are materials that contain olefinic functionality such as styrenic, acrylic and methacrylic moieties. Suitable silane coupling strategies are outlined in Silane Coupling Agents: Connecting Across Boundaries, by Barry Arkles, pg 165-189, Gelest Catalog 3000-A Silanes and Silicones: Gelest Inc. Morrisville, Pa.

Other illustrative examples of coupling agents include maleic anhydride-modified polypropylene and polyethylene.

Selection of suitable coupling agent will be dependent in part upon the compositions of the resin and microspheres and can be readily done by those with ordinary skill in the art.

Other Additives

If desired, composites of the invention may further comprise other additives and agents as desired. Illustrative examples include pigments, tackifiers, fire retardants, UV absorbents, light stabilizers, antiblocking agents, plasticizers, toughening agents, impact modifiers, antioxidants, nucleators, dispersants, antimicrobials, antistats, and processing aids.

| Designator | Formula, Structure and/or Name | Availability |
|---|---|---|
| Nylon 6,6 | ZYTEL ™ 101L: melt index of 60 g/10 m @ | DuPont, |
| | 275° C., T_{g} of 50° C., Tₘ of 260-262° C., and | Wilmington, |
| | density of 1.14 g/cm³ | DE |
| S60HS | Glass Bubbles; S60HS, density of 0.6 g/cm³, | 3M |
| | 18,000 psi (124.0 Mpa) 10% | Company, |
| | collapse strength | St. Paul, |
| | | MN |

Articles

Composites of the invention may be used to make a variety of articles as desired. Illustrative examples include transportation applications such as instrumental panel cores, engine covers, side impact panels, bumpers, fascia, o-rings, gaskets, brake pads, and hoses; molded household parts; composite sheets; thermoformed structural components, and wire and cable cladding. Other illustrative examples include potting compounds, panel structures, structural composite resins, plastic containers and pallets.

The invention will be further explained with the following illustrative examples.

### EXAMPLES

Compounding and Molding of Composites

All samples were compounded on a Berstorff Ultra Glide twin screw extruder (TSE; 25 mm screw diameter; Length to Diameter ratio of 36:1; available from Berstorff GmbH, Hannover, Germany) equipped with top feeders for microspheres and glass fibers, a water bath and pelletizer accessories. Screw speed ranged from 140 to 160 rpm. Temperature set points range from 200° F. to 575° F. (93° C. to 302° C.), while the actual values range from 500° F. to 575° F. (93° C. to 260° C.). TSE throughput was about 10 lbs/hr.

Test specimens were then molded on a 150 ton Engel Injection Molding Machine (available from ENGEL GmbH, Schwertberg, Austria) using an ASTM four cavity mold. The screw diameter used was 30 mm and the injection pressure was maintained below 18,000 psi (124 Mpa) to minimize microsphere breakage.

Test Methods

The following test methods were used.

Notched Izod Impact Strength was determined following ASTM D-256 and Unnotched Izod Impact Strength was determined following ASTM D-4812.

Tensile Modulus was determined following ASTM Test Method D-638 and is reported in Mpa.

Ultimate Tensile Strength was determined following ASTM Test Method D-638 and is reported in Mpa.

Flexural Modulus was determined following ASTM Test Method D-790 and is reported in Mpa.

Ultimate Flexural Strength was determined following ASTM Test Method D-790 and is reported in Mpa.

Elongation at Break was determined following ASTM Test Method D-638 and is reported as %.

Density of the injection molded composite material was determined according to ASTM D-2840-69, “Average True Particle Density of Hollow Microspheres” using a fully automated gas displacement pycnometer obtained under the trade designation “ACCUPYC 1330 PYCNOMETER” from Micromeritics, Norcross, Ga.

Physical Measurement Procedures

The densities of the injected molded composite samples were measured using a Micromeretics Accupyc 1330 Helium Pycnometer (available from Micromeritics Instrument Corporation, Norcross, Ga.). Mechanical and thermal properties of the injection-molded composites were measured using ATSTM standard test methods listed in Table 1.

TABLE 1

| Test | Designator | ASTM # |
|---|---|---|
| Tensile Modulus (Mpa) | TM | D-638 |
| Ultimate Tensile Strength (Mpa) | TS | D-638 |
| Flexural Modulus (Mpa) | FM | D-790 |
| Ultimate Flexural Strength (Mpa) | FS | D-790 |
| Elongation at Break (%) | EL | D-638 |
| Un-notched Izod Impact (J/cm) | UI | D-4812 |
| Notched Izod Impact (J/cm) | NI | D-256 |

TABLE 2
Table 2: Density, Strength and Size of commercial S60HS hollow glass
microspheres and experimental microspheres A & B

Bubble Properties

| Hydrostatic | |
|---|---|
| Strength | Size |

| Microsphere | Density | 10% Volume | D50 | D90 |
|---|---|---|---|---|
| Name | (g/cc) | Collapse (psi) | (μm) | (μm) |
| S60HS | 0.60 | 18000 | 29 | 45 |
| A | 0.62 | 19000 | 22 | 43 |
| B | 0.92 | 29000 | 18 | 35 |

S60HS microspheres and microspheres A& B were compounded into Nylon 6,6 resin on a twin screw extruder. ASTM Test specimens were then injection molded for the various formulations and typical mechanical properties were measured as per ASTM tests specified above. Results of the mechanical properties testing are shown in Table 3.

TABLE 3
Description of Formulations and Resulting Mechanical Properties

| | | | Impact Strength | | | | | | |
|---|---|---|---|---|---|---|---|---|---|
| | | | (ft-lb/inch) | | Tensile Properties | | | Flex Properties | |
| | Microspheres | Density | Notched | Unnotched | Strength | Modulus | Elongation | Strength | Modulus |
| Example | 20 weight percent | g/cc | Izod | Izod | (Mpa) | (Mpa) | (%) | (Mpa) | (Mpa) |
| C-1 | S60HS | 0.97 | 0.43 | 3.26 | 52.6 | 3524 | 1.6 | 77.3 | 3342 |
| 2 | Microsphere A | 1.00 | 0.48 | 4.45 | 57.4 | 3562 | 1.9 | 82.2 | 3361 |
| 3 | Microsphere B | 1.10 | 0.61 | 5.12 | 59.3 | 3556 | 2.7 | 86.2 | 3327 |

The results show that by incorporating smaller, stronger bubbles A or B into Nylon 6,6 improved mechanical properties (Impact Strength, Tensile Strength, Tensile Elongation and Flex Strength) are obtained as compared to S60HS in Nylon 6,6.

Several patent applications and patents are cited herein; each is incorporated by reference herein in its entirety.

Various modifications and alterations of this invention will become apparent to those skilled in the art without departing from the scope and spirit of this invention.

What is claimed is:

1. A filled resin composite comprising at least one polymeric resin and bubbles wherein said bubbles have an average size D50 of 25 micrometers or less and a 10 percent collapse strength of at least 10,000 PSI (68.8 Mpa)

2. The composite of claim 1 wherein said bubbles exhibit a 10 percent collapse strength of at least 15,000 PSI (103 Mpa ).

3. The composite of claim 1 wherein said bubbles exhibit a 10 percent collapse strength of at least 18,000 PSI (124 Mpa ).

4. The composite of claim 1 wherein said bubbles have an average size D50 of about 20 microns or less.

5. The composite of claim 1 wherein said bubbles have an average D90 size of about 50 microns or less.

6. The composite of claim 1 wherein said bubbles have an average D90 size of about 40 microns or less.

7. The composite of claim 1 wherein said bubbles have an average D50 size of about 25 micrometers or less and an average D90 size of about 50 micrometers or less.

8. The composite of claim 1 wherein said bubbles have an average D50 size of about 20 micrometers or less and an average D90 size of about 40 micrometers or less.

9. The composite of claim 1 wherein a majority of the bubbles in said composite have an average D50 size of about 20 micrometers or less and an average D90 size of about 40 micrometers or less.

10. The composite of claim 1 wherein over 75 percent of the bubbles in said composite have an average D50 size of about 20 micrometers or less and an average D90 size of about 40 micrometers or less.

11. The composite of claim 1 wherein said polymeric resin is selected from the group consisting of thermoset resins and thermoplastic resins.

12. The composite of claim 1 wherein said bubbles are selected from the group consisting of glass bubbles and ceramic bubbles.

13. An article comprising the composite of claim 1.
